(19) United States
(12) Patent Application Publication
(10) Pub. No.: US 2007/0209941 A1
(43) Pub. Date: Sep. 13, 2007

(54) Non-mechanical liquid crystal-based fluid control

(75) Inventors: Lisa Holland, Morgatown, WV (US); John L. West, Hartville, OH (US); Staffan Nilsson, Lund (SE); Theron John Pappas, Morgantown, WV (US)

Correspondence Address: WEST VIRGINIA UNIVERSITY RESEARCH CORPORATION, 886 CHESTNUT RIDGE ROAD, P.O. BOX 6216, MORGANTOWN, WV, 26506-6216, US

(73) Assignee: West Virginia Universtiy

(21) Appl. No.: 11/716,900

(22) Filed: Mar. 12, 2007

Related U.S. Application Data
(60) Provisional application No. 60/781,815, filed on Mar. 13, 2006.

(51) Int. Cl. G01N 27/00

(52) U.S. Cl. 204/601

(57) ABSTRACT

Fluidic flow is directed in a capillary or channel in a miniaturized separation or microfluidic device by the addition of liquid crystals to the fluid filling the channel. The liquid crystal medium undergoes changes in morphology upon the addition of external stimuli (magnetic and/or electric field and temperature). Under appropriate conditions this externally triggered change in liquid crystal produces a change in viscosity. This triggered change in viscosity directs fluid flow in multiple path channels and/or capillaries and therefore serves as a means of directing and controlling fluid flow within a capillary or channel in a miniaturized separation or microfluidic device.

### CROSS-REFERENCE TO RELATED APPLICATIONS

This application claims priority from application 60/781,815

### STATEMENT REGARDING FEDERALLY SPONSORED RESEARCH OR DEVELOPMENT

This invention was made with government support under Grant Nos. CHE00094121 and CHE0307245 awarded by the National Science Foundation. The United States government has certain rights in the invention.

### REFERENCE TO SEQUENCE LISTING, A TABLE, OR A COMPUTER PROGRAM LISTING COMPACT DISC APPENDIX

Not Applicable

### BACKGROUND OF THE INVENTION

The ability to control the flow of fluids is essential in small scale laboratory testing. Fluidic flow can be directed through miniaturized capillaries or channels for processing, separating or analyzing biological, physiological, environmental, forensic, or other samples. The current technology encompasses miniaturized separations and/or microfluidic devices. The channel or capillary dimension of this microfluidic technology is generally less than 200 micrometers in diameter. Typical dimensions range from 10-100 micrometer, although miniaturized devices with dimensions outside of this range are functional. Channel geometry may be: cylindrical, rectangular, or some other geometry such as hybrid cylindrical or rectangular shape. These miniaturized devices require smaller sample volume, and smaller volume of support media (for example running buffer, chromatographic stationary phase, and pseudo-stationary phase) than conventional devices. In addition, miniaturized devices can be fabricated such that they are portable, and therefore ideal for analysis in space constrained environments, or for field work as in environmental analyses, forensic analyses, or for clinical analyses.

In miniaturized devices, sample is introduced, manipulated, and frequently separated before it is detected and then quantified. Such a miniaturized device generally relies on fluid to carry, differentiate, and transport the components of the sample prior to detection. As such, a fluid-dependent miniaturized device requires chemical, physical, electrical, magnetic or mechanical means to drive, direct, and control the fluid. Fluid is introduced into the channel or capillary of a miniaturized device using conventional fluid pumps including reciprocating or syringe pumps, as well as pressure driven flow. Fluid may also be pumped by on-board or integrated electro osmotic flow or magneto-hydrodynamic pumping. A sophisticated miniaturized separation device also contains multiple flow paths to improve the function of the device by allowing greater flexibility in sample manipulation, for example as in PCR amplification, antibody capture, enzyme reaction, or chemical derivatization. Therefore, it is critical that the device affords a means to direct the fluid flow through desired paths in the multiple-path fluidic channels. Current strategies for micromechanical valve control for fluid control on microfluidic devices utilize polymer based actuators, micro-pneumatic valves, torque-actuated machine screws, biomimetic hydrogels, piezo-electric actuators, magneto hydrodynamic actuators, and rubber or polymer sheets. The main disadvantage with all of these methods is that they incorporate moving parts, which can be expensive and complicated to manufacture, may require specialized microfluidic production, and are prone to wear and leaks. Non-mechanical valves on microfluidic devices include thermally sensitive waxes or other materials, which have a limited lifetime; and ferrofluids, which are controlled by magnetic fields but are limited by substantial leakage and potential leaching. A further disadvantage is that the media used to drive the fluid flow is not fully compatible with the media responsible for separation or molecular manipulation, and therefore constrains or interferes with other processes on the miniaturized separation device. This incompatibility requires multiple tiered fabrications.

Liquid crystals are chemical entities, mixtures, assemblies or aggregates that have unique properties. The common phase states of matter include: solid, liquid, super-critical fluid, and gas. These phases are distinguished by atomic or molecular spacing, (distance between two entities) extent of atomic or molecular motion, and the degree of ordering. At the molecular level, solids are tightly packed molecules (or atoms), while liquids are closely spaced molecules (or atoms) that are mobile. These phases are also distinguished by physical properties: solids are generally rigid and immobile, whereas liquids flow. The term liquid crystal denotes a chemical entity, mixture, assembly or aggregate which has molecular order and packing similar to a solid, but unlike a solid, the entity, mixture, assembly or aggregate retains ability to move as a fluid. Multiple liquid crystal entities, mixtures, assemblies or aggregates will often display some long range order in response to external energy or stimuli such as temperature, electromagnetic radiation (light), electric field, or magnetic field. In response to external stimuli, liquid crystals often change orientation or long-range order as a stimulus is applied, removed, or varied. This characteristic is harnessed in liquid crystal display (LCD) technology.

Liquid crystals may change orientation, alignment, or long-range order; this may in turn result in a change in the physical properties of the liquid crystal media. In the case of this invention, the property that is harnessed is fluid viscosity and resistance to fluid flow. By applying external stimuli appropriately, either spatially or temporally, the flow resistance of a fluid within a particular separation channel or capillary can be increased or decreased. In hydrodynamic flow, fluid velocity is inversely related to viscosity. With all other conditions, held constant, higher viscosity media will have a lower velocity than lower viscosity medium. Therefore, if a liquid crystal medium undergoing hydrodynamic flow is presented with two flow paths, but one of the paths exposes the medium to a stimulus that induces an increase in fluid viscosity, while the alternate path does not, the liquid crystal medium will preferentially travel through the channel facilitating the lower fluid viscosity. In this mode, the path of the fluid liquid crystal can be directed within a miniaturized separation device by such a stimulus.

### BRIEF SUMMARY OF THE INVENTION

An aspect of the present invention is the addition of liquid crystals to a separation channel, such as those in a microfluidic device to create a variably viscous media within the channels of the device.

Another aspect of the present invention is the non-mechanical fluid control in a separation channel such as that in a microfluidic device by subjecting a liquid crystal medium to various external stimuli. The external stimuli include temperature, magnetic fields, electric fields, and any combination thereof. The external stimuli can be applied to various channels of the miniaturized separation or microfluidic device to create channels, or paths, of relatively high viscosity and other channels, or paths, with relatively low viscosity.

Another aspect of the invention is the variance of the mole ratio of mixed lipids that form liquid crystal media to induce differential response in viscosity throughout the microfluidic device.

A further aspect of the present invention is the adjustment of lipid composition to change viscosity and/or viscosity response of the liquid crystal medium.

Another aspect of the present invention is the ability to create by non-mechanical means, a viscous plug, thereby reducing flow through selected paths within a capillary or channel in a microfluidic device. The viscous plug created by the liquid crystal medium can be selectively imposed by the use of external stimuli on the liquid crystal medium. The external stimuli can be selectively applied to various channels to create fluid movement within the channel.

The present invention also discloses the ability to control the use of the various external stimuli on the liquid crystals by embedding the source of the external stimuli within the separation channel such as that in a microfluidic device. In the alternative, the separation channel such as that in a microfluidic device may be placed on a source to supply the external stimuli so that there is no embedding of the source within the microfluidic device.

Another aspect of the present invention is the ability to use the electric and magnetic fields in a perpendicular manner so that the viscosity of the liquid crystal medium can be rapidly changed.

One aspect of the invention is the use of the external stimuli on the liquid crystal, medium in a pressurized system to create separation channels to control fluid flow in a non-mechanical manner.

The present invention also discloses the ability to use the liquid crystal medium as a selective media in the absence of pressure driven flow. In an electrophoresis separation the liquid crystals can serve as a separation media.

An aspect of the present invention is the alignment of the liquid crystals when exposed to a magnetic field and/or an electric field. A further aspect of the invention is the effect of temperature on the morphology of the liquid crystal medium. This present invention discloses the ability to manipulate these external stimuli to create control over the fluids within the separation channel such as that in a capillary or channel in a miniaturized separation or microfluidic device.

The present invention further discloses the use of lanthanide ion chelators to further stabilize orientation of the liquid crystal structure during the selection of fluid flow.

### BRIEF DESCRIPTION OF THE SEVERAL VIEWS OF THE DRAWING

FIG. 1 is the chemical structure of 1,2-Dihexanoyl-sn-Glycero-3-Phosphocholine (DHPC).

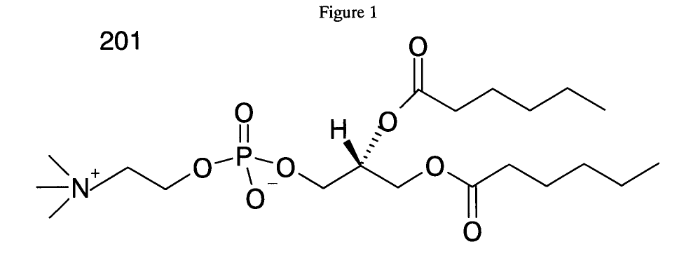

FIG. 2 is the chemical structure of 1,2-Dimyristoyl-sn-Glycero-3-Phosphocholine (DMPC).

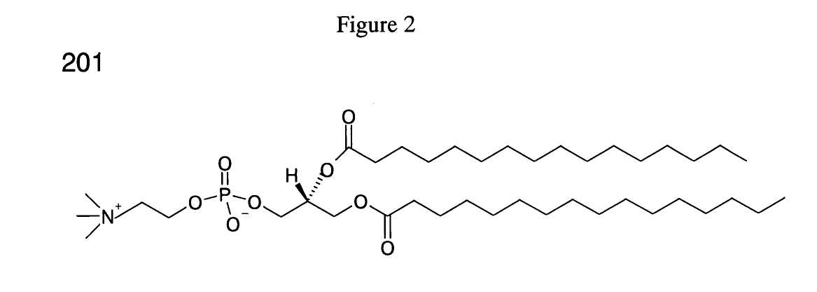

FIG. 3 is a graph showing the viscosity of the lanthanide doped liquid crystal comprised of DMPC and DHPC over a temperature range of 20° C. to 50° C. in the absence of an applied electric field.

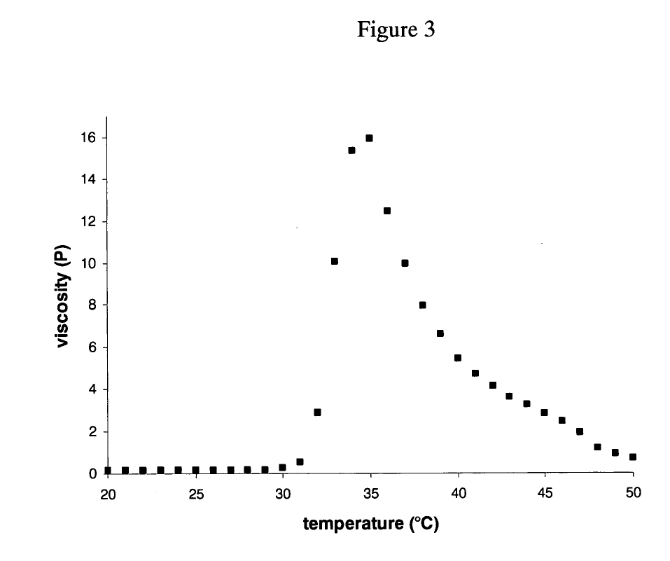

FIG. 4 is a graph showing the viscosity of the lanthanide doped liquid crystal comprised of DMPC and DHPC over a temperature range of 20° C. to 50° C. with the application of an electric field.

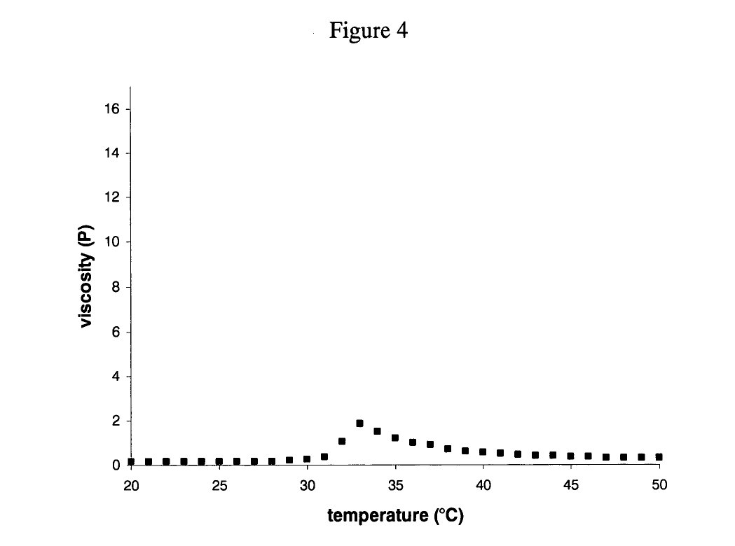

FIG. 5 is a graph showing the ratio of the viscosity of the lanthanide doped liquid crystal comprised of DMPC and DHPC without an applied electric field, over the viscosity of the lanthanide doped liquid crystal comprised of DMPC and DHPC with an applied electric field, over a temperature range of 20° C. to 50° C.

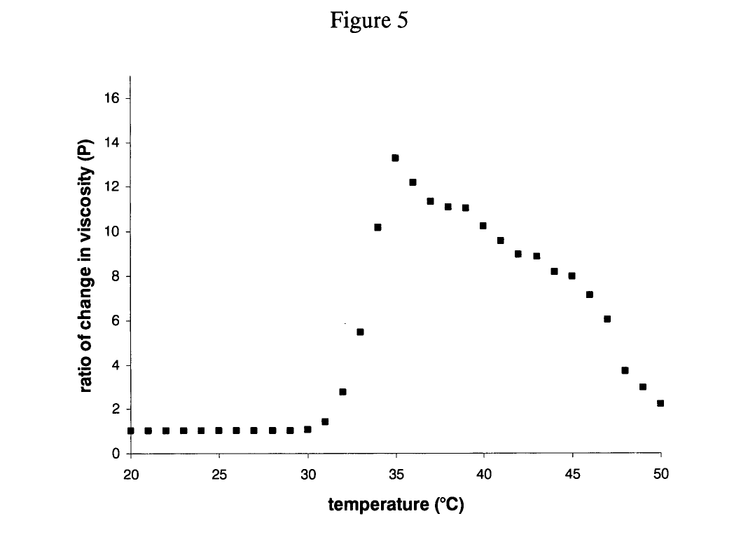

FIG. 6 is a generic miniaturized separation or microfluidic device under varying conditions.

FIG. 7 is a video capture image of non-mechanical flow control via (DMPC/DHPC/Yb³⁺) in a generic microfluidic device.

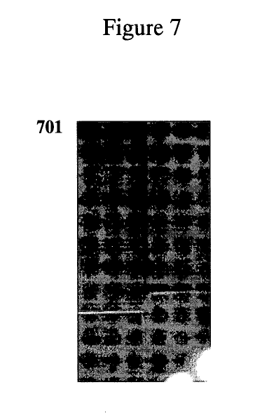

### DETAILED DESCRIPTION OF THE INVENTION

Controlling fluid flow with liquid crystal-based valves alleviates the common problems associated with the current mechanical and non-mechanical methods, because the liquid crystal medium can be introduced into any chip architecture and flow control can be dynamically programmed by applying external fields. The flow channel may be placed on, or fabricated with an integral platform of addressable electrodes, magnets, and thermal elements. A universal fabrication protocol that enables external stimuli to trigger liquid crystal viscosity creates a device for which any fluidic path can be instigated into any fluidic architecture. Finally, because the liquid crystal medium may be modified to simultaneously serve as the means for separation, the method of directing the fluid path is integrated with the separation methodology. In addition to the simplicity of implementation, these improvements will decrease the complexity of miniaturized separations or microfluidic devices. Further, they will increase the application flexibility and functionality of microfluidic separation technology. Liquid crystals have also been proven as a pseudo-stationary phase for separations (Holland & Leigh, 2003; Mills & Holland, 2004); the liquid crystal-based valves and separation mechanisms can be fully integrated. Therefore these liquid crystals may be used to direct fluid flow by appropriate application of external fields and may be used as the separation medium in the microfluidic device.

The present invention outlines a means to direct hydrodynamic-driven flow. The linear velocity of hydrodynamic flow (m/s) is inversely related to fluid viscosity, η, (v∝ 1/η) as derived by the Hagen-Poiseuille equation. A change in the viscosity of the fluid produces a change in the velocity of the fluid. The viscosity of a preparation of liquid crystal medium will change in response to external stimuli, therefore these liquid crystal preparations may be utilized to create a non-mechanical valve or plug for the control of fluids on a microfluidic device or a miniaturized separation device. A miniaturized separation device can be a microfluidic device, a capillary separation device or any other device used by one skilled in the art to separate amounts in lab-on-a-chip technology. Under certain conditions the viscosity of liquid crystals can be changed. The application of the following external stimuli singularly or in combination, can change the viscosity of a liquid crystal: temperature, electric field (current), and/or magnetic field. The external stimuli can induce a change in viscosity throughout the channels in a microfluidic device or within specific channels or regions of the device to promote fluid control. When applied to a channel, the mixture containing the liquid crystal medium becomes less viscous than channels in which electric field or magnetic field is applied. If hydrodynamic flow is applied to a channel with multiple branched channels, the fluid flux through each branched channel will be a function of the resistance to flow. As an example, in a channel containing two-paths, the rate of fluid flux through the channel with high flow resistance is lower than through the channel of low flow resistance. Flow resistance depends upon channel dimensions as well as viscosity. If channel dimensions are similar in a channel with multiple flow paths, as is the case in many or most miniaturized separation or microfluidic devices, hydrodynamic flow will be similar throughout the device. In a device where geometry does not lead to differential flow resistance, but viscosity is significantly different in the two channels, the flux will be higher in the channel of lower viscosity medium. Therefore by decreasing the viscosity of liquid crystal medium in one pathway relative to that in alternate pathways, fluid will preferentially flow in the pathway that induces lower viscosity of the medium.

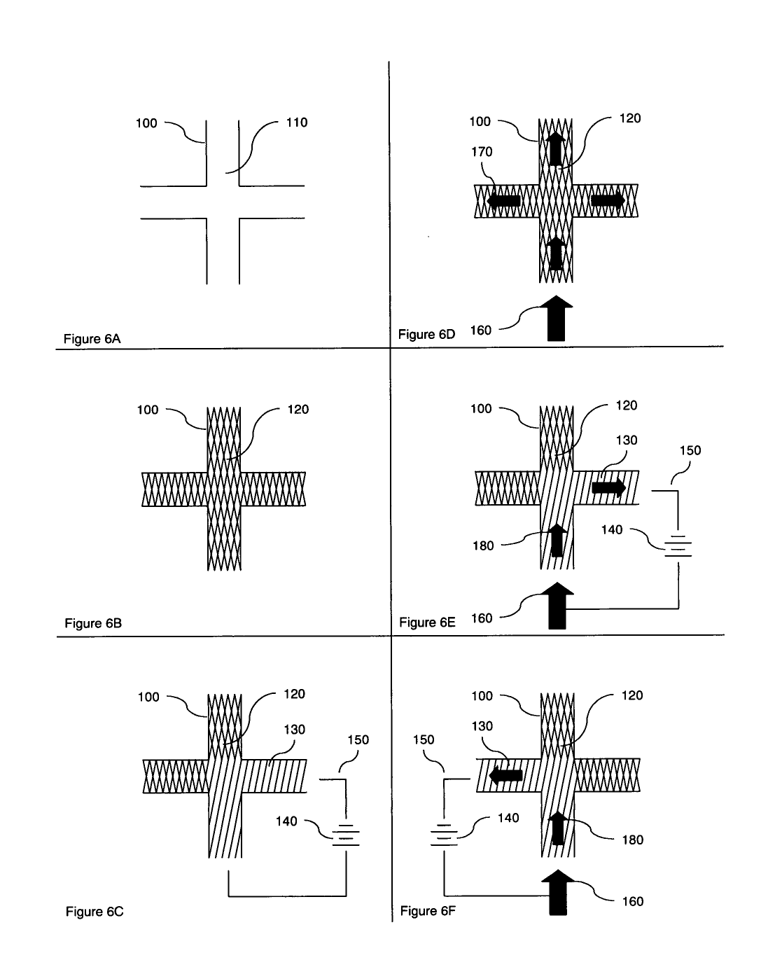

A microfluidic device containing a main channel that branches into a plurality of channels such as 3-channel paths with similar dimensions 100 is filled with a liquid crystal solution such as a solution of high viscosity lanthanide doped liquid crystal comprised of DMPC and DHPC 120 containing low concentration of background electrolyte to conduct electrical current from a power supply 140. Other lipids that could work in the bilayer are liquid crystals having similar characteristics as DMPC and DHPC such as DMPE (1,2-Dimyristoyl-sn-Glycero-3-Phosphoethanolamine) and DMPG (1,2-Dimyristoyl-sn-Glycero-3-[Phospho-rac-(1-glycerol)] (Sodium Salt)). The lanthanide ion may be any within the lanthanide series ions of the periodic table such as Tm³⁺ or Yb³⁺. Hydrodynamic flow 160 is then introduced into a port on the microfluidic device. The fluid will be distributed in similar proportion through the three channels 170. When an electric field is applied across two channels 150, in the presence of hydrodynamic flow 160 applied to one of these channels, the viscosity of the liquid crystal media drops significantly 130. Simultaneously, the viscosity of the liquid crystal medium in the channels to which no current is introduced remains high 120. When hydrodynamic flow is introduced into a port on the miniaturized separation or microfluidic device in conjunction with electric field, the fluid will preferentially travel through the channel filled with liquid crystal medium at lower viscosity 180. The higher viscosity of the plugged channel 120, may be restored after removing the electric field applied across the channel. It may also be restored by briefly pulsing electric or magnetic field perpendicular to the channel. By applying electric field between the channel which is to serve as the entry port for hydrodynamic flow and a different channel, the flow path may be changed as shown in FIGS. 6E and 6F. In an experimental setting, to distinguish between high viscosity and low viscosity liquid crystal comprised of DMPC and DHPC, the channels were filled with liquid crystal that also contained a dye (neutral red) 701. The microfluidic device is configured at shown in FIG. 6F. Following external stimuli (electric field), hydrodynamic flow delivers the liquid crystal medium that does not contain dye, and therefore appears clear. (1 μL/min, Electric field=140 V/cm, resulting current is 7 μA).

The preferred embodiment of the invention uses liquid crystal comprised of DMPC 201 and DHPC 200. This liquid crystal also contains a cation. This cation may associate with liquid crystal comprised of DMPC and DHPC, or with liquid crystal comprised of DMPC, DHPC, and lipid that is integrated with the liquid crystal comprised of DMPC and DHPC and is known to immobilize or sequester trivalent lanthanide ion, for example 1,2-dimyristoyl-sn-glycero-3-phosphoethanolaminediethylenetriaminepentaacetate (DMPG-DTPA). The liquid crystal comprised of DMPC and DHPC may benefit from or tolerate other lipid additives.

These molecules self-assemble in aqueous solution such that the long-chain DMPC phospholipid adopts a bilayer structure. The short-chain DHPC phospholipid may coat, or cap, the hydrophobic edges of the bilayer or it may assemble to form pore-like defects that span, or puncture, the bilayer structure created by the long-chain DMPC phospholipid. The mole ratio of the long chain lip to short chain lipid and temperature influences the morphology of the liquid crystal medium. While the width (thickness) of the hydrophobic bilayer is constant (˜40 Å), the surface area of the liquid crystal assembly can vary depending on the morphology. These aqueous liquid crystal phases are prepared by combining the effective mass of lipid, diluting it in aqueous solution, mixing the preparation, subjecting it to multiple cycles of freeze-thaw using liquid nitrogen and ambient temperature. Following the last freeze thaw cycle this preparation is centrifuged. These liquid crystal medium may be prepared by those of skill in the art and may be purchased commercially. When the ratio of long chain lipid 201 to short chain lipid 200 (the q value) is greater than 0 the liquid crystals undergo a morphology change. This change in morphology is more pronounced when the ratio of long chain lipid to short chain lipid is greater than 1.

In order for the liquid crystals to create an area of higher viscosity than that of another such that hydrodynamic or electro osmotic flow throughout said miniaturized separation device is diverted to areas with lower viscosity effective amounts of additives must be utilized. The effective amount of a q value for DMPC to DHPC ratio is greater than or equal to about 1.0. The effective amount of lanthanide is mole ratio (relative to the bicelle) greater than about 0.01. Further, there is a non-linear change in the viscosity of the liquid crystal medium with the external stimuli of temperature, current and magnetic fields. The effective amount of the external stimuli of temperature is about 20° C. to about 50° C. The effective amount of the external stimuli current is greater than about 1.0 μA. The effective amount of the external stimuli magnetic fields is from about 0.5T to about 1.5T. The an effective amount of a lipid such as 1,2-Distearoyl-sn-Glycero-3-Phosphoethanolamine-N-[Methoxy(Polyethylen glycol)-2000] is a mole ratio (relative to the bicelle) greater than about 0.01. A lipid chelator may also be used and an effective amount is mole ratio (relative to the bicelle) of about 0.03.

The means to control the external stimuli may be any known by one skilled in the art for control of temperature, current, and magnetic field in a microfluidic device or miniaturized separation device. The external stimuli may be added either from an external source or from within the microfluidic device itself. The external stimuli of current may be supplied by an array of high voltage interdigitated electrodes capable of applying a series of current pathways on said microfluidic device. Another embodiment can have the current provided by a platform of addressable electrodes while the temperature and magnetic field are supplied externally. In addition, a further embodiment of the invention may have the addition of the current and magnetic field across the channel walls of the microfluidic device. The external stimuli may be used to create a viscosity gradient within the microfluidic device to allow the flow throughout the device in a desired course. In order to achieve gradient of hydrodynamic pressure the means to control the current temperature and magnetic fields may be applied at different intensities across the microfluidic device or in a series. The external stimuli of a magnetic field and current may also be perpendicular to each other.

There is ongoing discussion of the morphology of liquid crystal comprised of DMPC and DHPC. Experimental reports show evidence of the existence of the classical DMPC and DHPC bilayered disk, mixed bicelles, entangled ribbons, chiral nematic wormlike bicelles, perforated multilamellar vesicles, mixed multilamellar vesicles, extended lamellae, and unilamellar vesicles (Gutberlet, Hoell, Kammel, Frank, & Katsaras, 2002; Harroun et al., 2005; M. P. Nieh et al., 2004; M. P. Nieh et al., 2005; Raffard, Steinbruckner, Arnold, Davis, & Dufourc, 2000; Rowe & Neal, 2003; Sanders III & Schwonek, 1992; Sternin, D. Nizza, & Gawrisch, 2001; Triba, Warschawski, & Devaux, 2005). Liquid crystals comprised of DMPC and DHPC are commonly used in solid state NMR because they align in a magnetic field, which enhances signal for membrane associated, soluble or anchored peptides and proteins.

The lanthanide doped liquid crystal media comprised of DMPC and DHPC produced a 14 fold change in viscosity at 35° C. Neutral analyte transported by hydrodynamic flow with or without superimposed electric field demonstrated different velocity (measured as transport time to the detection window over a fixed distance), in both a separation capillary and microfluidic devices in the presence of Yb³⁺. This phenomenon was observed at several temperatures for a lanthanide doped liquid crystal comprised of DMPC and DHPC. It has been reported that this lanthanide bind to lipid phosphodiester groups and form a more ordered phase in the presence of magnetic field (Prosser, Hwang, & Vold, 1998; Prosser & Shiyanovskaya, 2001). In the presence of a magnetic field, the lanthanide doped liquid crystal medium comprised of DMPC and DHPC “flip” bilayer alignment relative to the magnetic field 90 degrees, forming a more ordered phase. Thus, in lanthanide doped DMPC/DHPC liquid crystals, the bilayer normal is parallel with the magnetic field. Work in this area has also demonstrated that if the liquid crystal is modified with lipid that chelates lanthanide ions the bilayer morphology is further stabilized (Prosser, Volkov, & Shiyanovskaya, 1998a, 1998b). Finally, temperature induced viscosity change of DMPC/DHPC liquid crystals doped with Tm³⁺ has been noted, and morphology reported as perforated lamellar, or unilamellar vesicular, at high viscosity and discoidal for low viscosity (M.-P. Nieh, Glinka, Krueger, Prosser, & Katsaras, 2001).

Finally, temperature induced viscosity change of liquid crystal comprised of DMPC and DHPC doped with other trivalent lanthanides has been noted, and morphology reported as perforated lamellar, or unilamellar vesicular, at high viscosity and discoidal for low viscosity (M.-P. Nieh et al., 2001).

Liquid crystal comprised of DMPC and DHPC align in response to external magnetic and electric fields. These alignments create either a valve or a plug. The valve will control the flow throughout the microfluidic device while a plug will create an area of high viscosity to force flow to areas of lower viscosity. This document constitutes the first report of the effect of electric field on viscosity of a liquid crystal media comprised of DMPC and DHPC which is doped with trivalent lanthanide. The lanthanide doped liquid crystal medium comprised of DMPC and DHPC forms a more ordered liquid crystal phase. This phase may form “layers” with additional long-range order to keep the positional order of the group in a single direction. Ytterbium (Yb³⁺) ions are the preferred lanthanide ion in this invention, although other ions are not excluded from use. The preferred temperature for difference in viscosity with the application of electric or magnetic fields for q 2.5 bicelle doped with lanthanide at a mole ratio of 2.5/1.0/0.2: DMPC/DHPC/Yb³⁺ is 35° C. There was a 14 fold difference in viscosity at this temperature. Changes in the liquid crystal composition will effect the viscosity temperature relation. A variety of liquid crystal compositions can be used to perform the same tasks.

These attributes of liquid crystals comprised of DMPC and DHPC may be harnessed for non-mechanical flow control in lab-on-a-chip devices. The lanthanide doped liquid crystals comprised of DMPC and DHPC exhibit significant change in viscosity in the presence of electric field. In the absence of field, the liquid crystal is more viscous and produces high flow resistance to hydrodynamic flow, resulting low linear flow velocity. In the presence of field, the viscosity decreases dramatically and produces low flow resistance to hydrodynamic flow, resulting in high linear flow velocity. Based on our experimental data and literature reports of lanthanide doped liquid crystals comprised of DMPC and DHPC, we hypothesize the reason for this change in viscosity is due to extended bilayer structures that fail to align, or align in an electric field to form a more ordered phase. Without lanthanide doping, these extended bilayer structures fail to align, or align to produce a less ordered phase.

In a microfluidic device this means when a pump drives fluidic flow, an externally applied electric field can be superimposed to select the flow path within the chip. When the pump is turned off, the electric field will drive the electrophoresis separation. Therefore, a lab-on-a chip device with liquid crystals comprised of DMPC and DHPC in the separation channels can provide externally triggered non-mechanical flow control when pressure and field are applied simultaneously. In the absence of pressure driven flow, liquid crystals comprised of DMPC and DHPC serve as a selective media in an electrophoresis separation.

Placing the flow channel on a platform of addressable electrodes creates a universal fabrication protocol so that any fluidic path can instigated into any fluidic architecture. However, the temperature or magnetic field devices can be supplied externally from the microfluidic device.

Another embodiment of the disclosed invention could allow for rapid switching of the valves from opened to closed or vice versa. It is believed that changing the orientation of the electric and/or magnetic field such that the field is imposed across the channel wall rather than through the channel itself would also disrupt liquid crystal orientation and therefore viscosity.

The addition of a pump imposes hydrodynamic flow within the capillary or channel of the miniaturized separation or microfluidic device to allow the less viscous channels to preferentially accommodate fluid flow. The preferred pump for the non-mechanical valve and fluid control is a syringe pump. However, any pump such as a reciprocating pump, or other conventional means of external hydrodynamic flow control would suffice.

The non-mechanical fluid control has many applications including the controlling the direction of fluid flow within a microfluidic device. The non-pressurized microfluidic device can be used as well for electrophoresis separation. Additionally, the use of liquid crystals to change viscosity could be used to anchor antibody or protein for analyte capture, enzymatic manipulation, and/or separation.

These terms and specifications, including the examples, serve to describe the invention by example and not to limit the invention. It is expected that others will perceive differences, which, while differing from the forgoing, do not depart from the scope of the invention herein described and claimed. In particular, any of the function elements described herein may be replaced by any other known element having an equivalent function.

### REFERENCES

Gutberlet, T., Hoell, A., Kammel, M., Frank, J., & Katsaras, J. (2002). Neutron scattering from magnetically aligned biomimetic substrates. Applied Physics A: Materials Science & Processing, 74, S1260-1261.
Harroun, T. A., Koslowsky, M., Nieh, M.-P., deLannoy, C.-F., Raghunathan, V. A., & Katsaras, J. (2005). Comprehensive Examination of Mesophases Formed by DMPC and DHPC Mixtures. Langmuir, 21, 5356-5361.
Holland, L. A., & Leigh, A. M. (2003). Bilayered phospholipid micelles and capillary electrophoresis: A new additive for electrokinetic chromatography. Electrophoresis, 24, 2935-2939.
Mills, J., & Holland, L. A. (2004). Membrane mediated capillary electrophoresis: Interaction of cationic peptides with bicelles. Electrophoresis, 25, 1237-1242.
Nieh, M.-P., Glinka, C. J., Krueger, S. R., Prosser, R. S., & Katsaras, J. (2001). SANS study of the structural phases of magnetically alignable lanthanide-doped phospholipid mixtures. Langmuir, 17, 2629-2638.
Nieh, M. P., Raghunathan, V. A., Glinka, C. J., Harroun, T. A., Pabst, G., & Katsaras, J. (2004). Magentically alignable phase of phospholipid “bicelle” mixtures is a chiral nematic made up of wormlike micelles. Langmuir, 20, 7893-7897.
Nieh, M. P., Raghunathan, V. A., Kline, S. R., Harroun, T. A., Huang, C.-Y., Pencer, J., et al. (2005). Spontaneously Formed Unilamellar Vesicles with Path-Dependent Size Distribution. Langmuir, 21, 6656-6661.
Prosser, R. S., Hwang, J. S., & Vold, R. R. (1998). Magnetically aligned phospholipid bilayers with positive ordering: a new model membrane system. Biophysical Journal, 74, 2405-2418.
Prosser, R. S., & Shiyanovskaya, I. V. (2001). Lanthanide ion assisted magnetic alignment of model membranes and macromolecules. Concepts in Magnetic Resonance, 13, 19-31.
Prosser, R. S., Volkov, V. B., & Shiyanovskaya, I. V. (1998a). Novel chelate-induced magnetic alignment of biological membranes. Biophysical Journal, 75, 2163-2169.
Prosser, R. S., Volkov, V. B., & Shiyanovskaya, I. V. (1998b). Solid-state NMR studies of magnetically aligned phospholipid membranes: taming lanthanides for membrane protein studies. Biochem Cell Biol, 76, 443-451.
Raffard, G., Steinbruckner, S., Arnold, A., Davis, J. H., & Dufourc, E. J. (2000). Temperature-composition diagram of dimyristoylphosphatidylcholine-dicaproylphosphatidylcholine “bicelles” self-orienting in the magnetic field. A solid state 2H and 31P NMR study. Langmuir, 16, 7655-7662.
Rowe, B. A., & Neal, S. L. (2003). Fluorescence Probe Study of Bicelle Structure as a Function of Temperature: Developing a Practical Bicelle Structure Model. Langmuir, 19, 2039-2048.
Sanders III, C. R., & Schwonek, J. P. (1992). Characterization of magnetically orientable bilayers in mixtures of dihexanoylphospahtidylcholine and dimyristoylphosphatidylcholine by solid-state NMR. Biochemistry, 31, 8898-8905.
Sternin, E., D. Nizza, & Gawrisch, K. (2001). Temperature Dependence of DMPC/DHPC Mixing in a Bicellar Solution and Its Structural Implications. Langmuir, 17, 2610-2616.
Triba, M. N., Warschawski, D. E., & Devaux, P. F. (2005). Reinvestigation by Phorphorous NMR of Lipid Distribution in Bicelles. Biophysical Journal, 88, 1887-1901.

What is claimed is:

1. A microfluidic device comprising a plurality of channels within said microfluidic device, a means to add and control one or more of the external stimuli of temperature, current, and magnetic fields to said microfluidic device, an effective amount of a liquid crystal in an electrolyte buffer applied to said microfluidic device wherein said liquid crystal has a viscosity which can be modulated by said external stimuli to control fluid flow through said plurality of channels.

2. The microfluidic device of claim 1 wherein said liquid crystals serve as a selective media in an electrophoresis separation.

3. The microfluidic device of claim 1 wherein said means to control current is an array of high voltage interdigitated electrodes capable of applying a series of current pathways on said microfluidic device.

4. The microfluidic device of claim 1 wherein said liquid crystals are an effective ratio of DMPC to DPHC.

5. The microfluidic device of claim 4 further comprising an effective amount of a lanthanide ion.

6. The microfluidic device of claim 4 further comprising an effective amount of 1,2-Distearoylsn-Glycero-3-Phosphoethanolamine-N-[Methoxy(Polyethylen glycol)-2000].

7. The microfluidic device of claim 4 further comprising a lipid chelator.

8. The microfluidic device of claim 1 further comprising a pump.

9. The microfluidic device of claim 8 further comprising said means to control current, temperature, and magnetic fields applied at different intensities throughout said microfluidic device.

10. The microfluidic device of claim 9 wherein an effective amount of said selective addition of external stimuli creates a viscosity gradient within said microfluidic device to allow flow through a desired course.

11. The microfluidic device of claim 1 further comprising the addition of said current and said magnetic field across said channel walls.

12. A non-mechanical valve comprising a miniaturized separation device, a means to add and control one or more of the external stimuli of current, magnetic fields, and temperature within said miniaturized separation device, an effective amount of liquid crystals within said miniaturized separation device wherein said liquid crystals are exposed to said external stimuli to increase or decrease the viscosity of said liquid crystals and create an area of higher viscosity such that hydrodynamic or electro osmotic flow throughout said miniaturized separation device is diverted to areas with lower viscosity

13. The non-mechanical valve of claim 12 wherein said liquid crystals are an effective ratio of DMPC and DHPC.

14. The non-mechanical valve of claim 13 further comprising the addition of at least one additive chosen from 1,2-Distearoylsn-Glycero-3-Phosphoethanolamine-N-[Methoxy(Polyethylen glycol)-2000], a lipid chelator, or a lanthanide ion.

15. The non-mechanical valve of claim 12 wherein an effective amount of said external stimuli are used in a series to modulate viscosity changes on the miniaturized separation device such that a gradient of hydrodynamic pressure is created.

16. The non-mechanical valve of claim 12 wherein said current and said magnetic field are perpendicular to each other.

17. The non-mechanical valve of claim 12 wherein said means to add and control one or more external stimuli are placed within said miniaturized separation device.

18. The non-mechanical valve of claim 12 wherein said current is provided by a platform of addressable electrodes and said temperature and said magnetic field are supplied externally.

19. A non-mechanical plug comprising microfluidic device further comprising a plurality of channels, a means to add and control one or more of the external stimuli of current, magnetic fields, and temperature in an effective amount within said microfluidic device, a pump, and an effective amount of liquid crystals wherein said external stimuli are added to selected channels to decrease viscosity within said channel and prevent fluid flow into thereby creating a plug in non-stimulated channels.

20. The non-mechanical plug of claim 20 wherein said change in viscosity can be used to anchor an antibody or a protein in said plugged channel.
